(19) United States
(12) Patent Application Publication
(10) Pub. No.: US 2025/0047230 A1
(43) Pub. Date: Feb. 6, 2025

(54) Outdoor Structure Having a Watertight Roof System Including Bifacial Solar Panels and Methods of Making and Using Same

(71) Applicant: James M. Gallagher, SR., Wyoming, PA (US)

(72) Inventor: James M. Gallagher, SR., Wyoming, PA (US)

(21) Appl. No.: 18/791,023

(22) Filed: Jul. 31, 2024

Related U.S. Application Data
(60) Provisional application No. 63/517,764, filed on Aug. 4, 2023.

(51) Int. Cl. H02S 20/23

(52) U.S. Cl. CPC H02S 20/23

(57) ABSTRACT

Systems, methods, and other embodiments for a roofing system for an outdoor structure, including an outdoor structure, and a roofing system, wherein the roofing system further includes; at least one bifacial solar panel assembly configured to produce solar energy, and a rail assembly, wherein the at least one bifacial solar panel assembly is removably retained within the rail assembly, and the rail assembly includes a plurality of extensions that contact an upper side of the least one bifacial solar panel assembly to create a watertight seal around a periphery of the at least one bifacial solar assembly.

### CROSS-REFERENCE TO RELATED APPLICATION

This application claims the benefit of U.S. Patent Application 63/517,764 filed on Aug. 4, 2023, the disclosure of which is hereby incorporated by reference in its entirety to provide continuity of disclosure to the extent such disclosure is not inconsistent with this disclosure.

### FIELD OF THE INVENTION

The present invention relates to an outdoor structure such as a veranda, pergola, car port, gazebo or the like wherein the outdoor structure has a watertight roofing system which includes solar panels. In particular, the outdoor structure is constructed with a roofing system that includes a plurality of bifacial solar panels that combined with the watertight roofing truss system, make up the actual roof, assembled with the designed product. The plurality of bifacial solar panels is retained through the use of several different types of rails in order to create a watertight roofing structure. Also, the watertight roofing system is retained on the top of the outdoor structure at an adjustable angle so that any rain, snow, sleet, hail or other similar type of precipitation will easily run off or drain off of the watertight roofing system. Furthermore, the bifacial solar panels can be quickly and easily located within and retained within the rails in order to create the watertight roofing system. Finally, the roofing system can be used to produce solar energy that can be used to charge, for example, an electronic vehicle located under the outdoor structure and/or used to feed the electricity produced from the solar energy back into the national grid system.

### BACKGROUND OF THE INVENTION

It is known that solar panels can be placed on a variety of locations and structures. For instance, solar panels can be placed on roofs of houses and other similar structures. However, when building a car port/veranda to create a watertight, electrical back feed charging station using bifacial solar panels, it was immediately recognized that there was a total lack of an available commercial product of a watertight roofing system that would serve as the roofing system for connected bifacial solar panels.

Furthermore, there is no standard system to accept solar panels that is watertight and has a range in the curvature of the rail angle from 1.2″ to 1.5″ to accept a variety in range of sizes in the solar panels currently produced. Currently, the solar panels are located within rails and then the areas where the solar panels and the rails meet must be conventionally sealed through the use of caulking or other similar time-consuming sealants. However, if a solar panel needs to be replaced, the sealant must be removed, the old solar panel is removed, the new solar panel is located where the old solar panel was located, and new sealant must be applied to the new solar panel and the rail which is time consuming and costly. Conversely, the solar roof panel system of the present invention eliminates applying any type of caulking directly to the solar panel and caulking is minimally used at abutting points of the rails and only applied on the rails (e.g., never applied directly to the solar panel itself).

This invention's purpose is to fulfill these and other needs in the outdoor structure roofing system art in a manner more apparent to the skilled artisan once given the following disclosure.

The preferred roofing system for an outdoor structure, according to various embodiments of the present invention, offers the following advantages: ease of use; portability; reduced cost; reduced weight; improved watertightness; ease of replacement of a solar panel; the improved use of bifacial solar panels; ease of construction; the ability to adjust the pitch/angle of the roofing system; the ability to provide protection from the outdoor elements; the ability to provide a solar power station that can be used to charge electronic devices located under the outdoor structure; and the ability to feed the electricity produced from the solar energy back into the national grid system. In many of the preferred embodiments, these advantages are optimized to the extent that is considerably higher than previously achieved in prior known roofing systems for an outdoor structure.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a schematic illustration of a butterfly rail with an extended top, according to various embodiments of the present invention described herein.

FIG. 2 is a schematic illustration of an end rail with an extended top, according to various embodiments of the present invention described herein.

FIG. 3 is a schematic illustration of a butterfly connector with an extended top, according to various embodiments of the present invention described herein.

FIG. 4 is a schematic illustration of a plurality of bifacial solar panels being located and retained within a butterfly rail and a butterfly connector, according to various embodiments of the present invention described herein.

FIG. 5 is a schematic illustration of a plurality of bifacial solar panels being located and retained within an end rail and a butterfly connector, according to various embodiments of the present invention described herein.

FIG. 6 is a schematic illustration of a solar panel pitch connector assembly, according to various embodiments of the present invention described herein.

FIG. 7 is a schematic illustration of an outdoor structure having a watertight roofing system including bifacial solar panels, according to various embodiments of the present invention described herein.

FIG. 8 is a schematic illustration of an electrical power feedback to the electrical grid system, according to various embodiments of the present invention described herein.

### DETAILED DESCRIPTION OF THE INVENTION

The terminology used herein is to describe particular embodiments only and is not intended to be limiting to the invention. As used herein, the term “and/or” includes any and all combinations of one or more of the associated listed items. As used herein, singular forms “a”, “an”, and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new outdoor structure having a watertight roofing system including bifacial solar panels and methods for making and using is discussed herein. In the following description, for purposes of explanation, numerous specific details are set forth to provide a thorough understanding of the present invention. It will be evident, however, to one skilled in the art that the present invention may be practiced without these specific details.

The present disclosure is considered an exemplification of the invention and is not intended to limit the invention to the specific embodiments illustrated by the figures or description below.

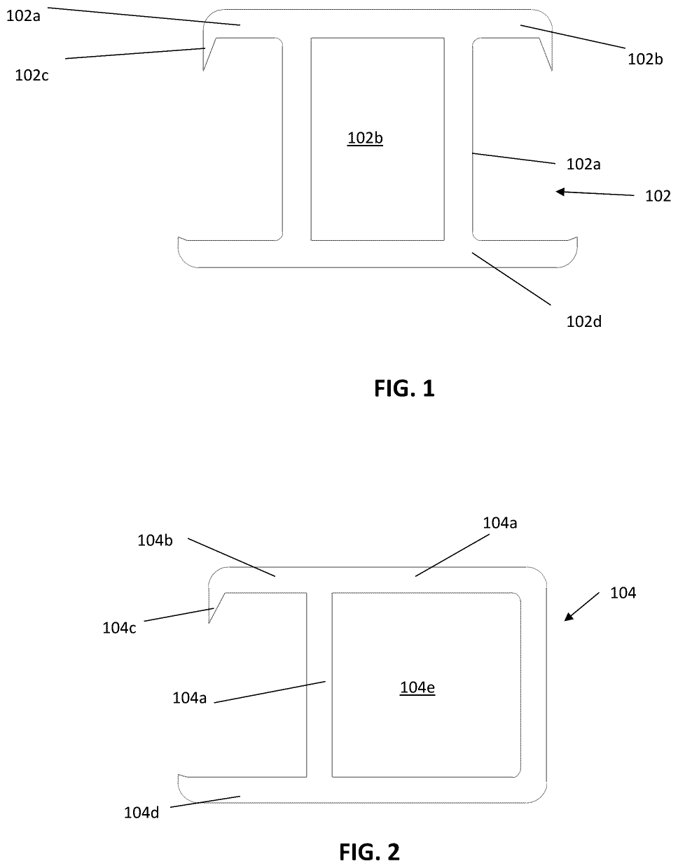

The present invention will now be described by referencing the appended figures representing preferred embodiments. FIGS. 1-8 are illustrations of an outdoor structure having a watertight roofing system including bifacial solar panels.

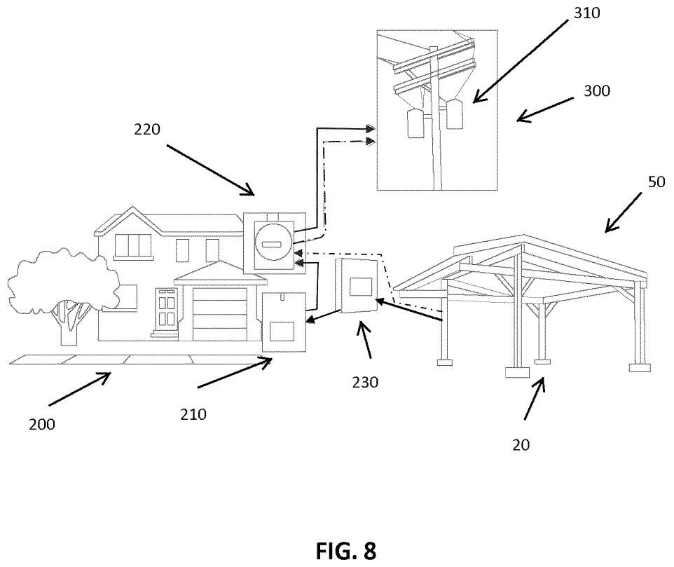

In particular, as shown in FIGS. 1-8, there is illustrated an outside structure 2 such as a veranda, pergola, car port, gazebo or the like wherein the outdoor structure 2 has a watertight roofing system 20 which includes solar panels 50. In particular, the outdoor structure 2 is constructed with a roofing system 20 that includes a plurality of bifacial solar panels 50 that are retained on the top of the outdoor structure 2. The plurality of bifacial solar panels 50 are retained through the use of a rail assembly 100 in order to create a watertight roofing structure 2. Also, the watertight roofing system 20 is retained on the top of the outdoor structure 2 at an adjustable angle through the use of a solar panel pitch connector assembly 150 so that any rain, snow, sleet, hail or other similar type of precipitation will easily run off or drain off of the watertight roofing system 20. Furthermore, the bifacial solar panels 50 can be quickly and easily located within and retained within the rail assembly 100 in order to create the watertight roofing system 20. Finally, the roofing system 20 can be used to produce solar energy that can be used to charge, for example, an electronic vehicle (not shown) located under the outdoor structure and/or used to feed the electricity produced from the solar energy back into the national grid system (FIG. 8).

### Outside Structure 2

As shown in FIG. 7, outside structure 2 further includes a plurality of posts 4 and a plurality of crossbeams 8. It is to be understood that conventional rollers 6 or other similar devices can be attached to the bottom of each post 4 so that outside structure 2 can be moved from one location to another. It is to be understood that outside structure 2 can also be permanently attached to the ground, as is well known within the art.

### Bifacial Solar Panels 50

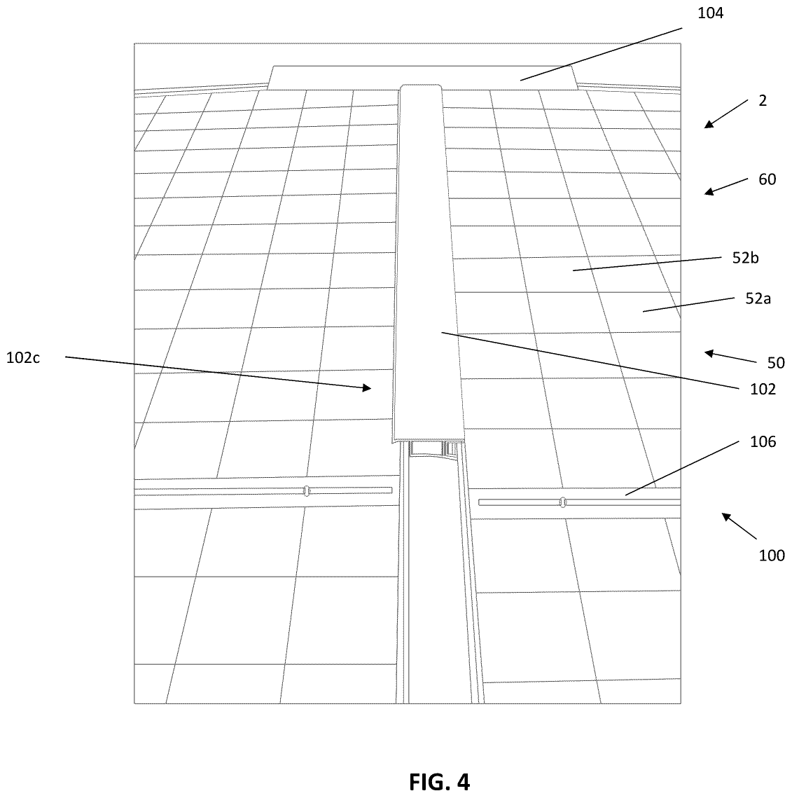

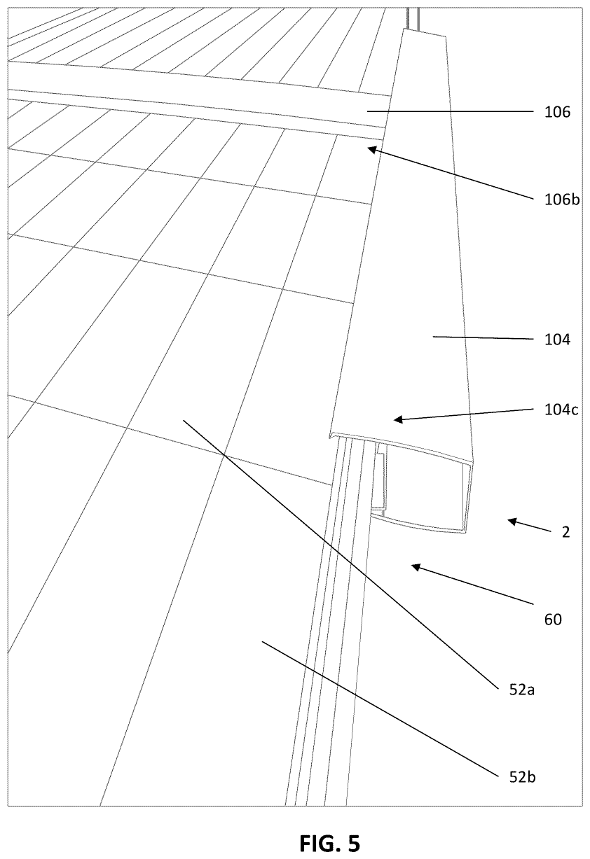

Regarding bifacial solar panels 50, as shown in FIGS. 4, 5, and 7, outside structure 2 further includes a plurality of bifacial solar panels 50. In particular, as shown in FIGS. 4 and 5, bifacial solar panels 50 include, in part, individual bifacial solar panels 50a and 50b. It is to be understood that the remainder of the bifacial solar panels 50 shown in FIGS. 4, 5, and 7 are similar to bifacial solar panels 50a and 50b. It is to be understood that a plurality of bifacial solar panels 50a and 50b can be conventionally attached together to form a solar panel assembly 60.

A unique aspect of the present invention is the use of the bifacial solar panels 50. Since the bi-facial panels 50 require less pitch (5-7 degrees) and higher clearances for reflective solar output, the bifacial solar panels 50 can be used in roofing systems for outdoor structures such as carports and veranda style units and can be used to produce solar energy. Also, the bifacial solar panels 50 can be used to create a watertight roofing structure to keep inclement weather off of vehicles, patio furniture, etc. that can be located under the watertight roofing structure.

Furthermore, the bifacial solar panels 50 have solar cells on both sides. This enables the bifacial solar panels 50 to absorb light from the back as well as the front. In this manner, each bifacial solar panel 50 can absorb light that is reflected off the ground or another material and requires less space.

### Rail Assembly 100

In order to retain the bifacial solar panels 50 onto outdoor structure 2, rail assembly 100 is used. As shown in FIGS. 1-5, rail assembly 100 includes, in part, butterfly rails 102, end rails 104, and butterfly connectors 106. Preferably, butterfly rails 102, end rails 104, and butterfly connectors 106 are constructed of any suitable, durable, lightweight, high strength, rust resistant, UV-resistant material such as vinyl, aluminum, or rigid polyvinyl chloride (rigid PVC). It is to be understood that the butterfly rails 102, end rails 104, and butterfly connectors 106 can be constructed by conventional techniques such as extrusion, forming, molding or the like.

With respect to FIG. 1, there is illustrated a cross-section of a butterfly rail 102. Butterfly rail 102 includes, in part, butterfly rail frame 102a, top wall 102b, extension 102c, bottom wall 102d, and frame opening 102e. Preferably, butterfly rail 102 is constructed by conventional techniques such as extrusion, forming, molding or the like. Preferably, frame 102a is constructed with a thickness range of ⅛″ to ¼″. A unique aspect of the present invention is that the bottom wall 102d extends a distance beyond the top wall 102b in order to provide more support for the solar panel assembly 60, as will be discussed in greater detail later.

With respect to FIG. 2, there is illustrated a cross-section of an end rail 104. End rail 104 includes, in part, end rail frame 104a, top wall 104b, extension 104c, bottom wall 104d, and frame opening 104e. Preferably, end rail 104 is constructed by conventional techniques such as extrusion, forming, molding or the like. Preferably, frame 104a is constructed with a thickness range of ⅛″ to ¼″. A unique aspect of the present invention is that the bottom wall 104d extends a distance beyond the top wall 104b in order to provide more support for the solar panel assembly 60, as will be discussed in greater detail later.

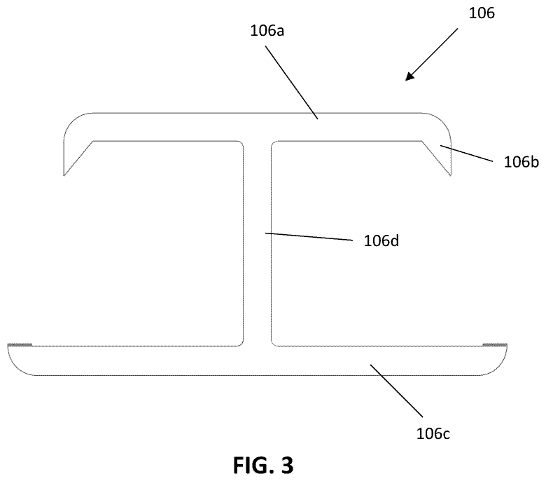

With respect to FIG. 3, there is illustrated a cross-section of a butterfly connector 106. Butterfly connector 106 includes, in part, top wall 106a, extension 106b, bottom wall 106c, and butterfly connector frame 106d. Preferably, butterfly connector 106 is constructed by conventional techniques such as extrusion, forming, molding or the like. Preferably, frame 106d is constructed with a thickness range of ⅛″ to ¼″. A unique aspect of the present invention is that the bottom wall 106c extends a distance beyond the top wall 106a in order to provide more support for the solar panel assembly 60, as will be discussed in greater detail later.

A unique aspect of the present invention is the use of rail assembly 100 in conjunction with bifacial solar panels 50. As best shown in FIGS. 4 and 5, in order to properly retain the bifacial solar panels 50 onto the top of the outdoor structure 2, rail assembly 100 is utilized. In particular, as shown in FIGS. 4 and 5, a solar panel assembly 60 is located along its edge within the top wall and bottom wall of butterfly rail 102. It is to be understood that solar panel assembly 60 includes a plurality of bifacial solar panels 50. Typically, each solar panel assembly 60 includes a rectangular array of bifacial solar panels 50. Furthermore, at least one end of each of the solar panel assemblies 60 are retained together through the use of butterfly connectors 106. Finally, the other end of each solar panel assembly 60 is connected to the end rails 104.

Another unique aspect of the present invention is the use of the extensions 102c, 104c, and 106b. In particular, as shown in FIGS. 4 and 5, solar panel assembly 60 is located and retained within butterfly rails 102, end rails 104, and butterfly connectors 106. Preferably, extensions should extend a predetermined distance (from 0.15-0.25 inches below the top wall 102b, 104b, and 106a, respectively). In this manner, the extensions 102c, 104c, and 106b can contact the top of each solar panel assembly 60 in order to create a watertight seal the areas where the extensions 102c, 104c, and 106b contact the top of the solar panel assembly 60 (i.e., between the top of the solar panel assembly 60 and the butterfly rails 102, end rails 104, and butterfly connectors 106). However, it is to be understood that in the areas where the butterfly rails 102, end rails 104, and butterfly connectors 106 meet up with each other, a conventional sealant (i.e., caulking or the like) can be applied in order to ensure a watertight seal.

### Solar Panel Pitch Connector Assembly 150

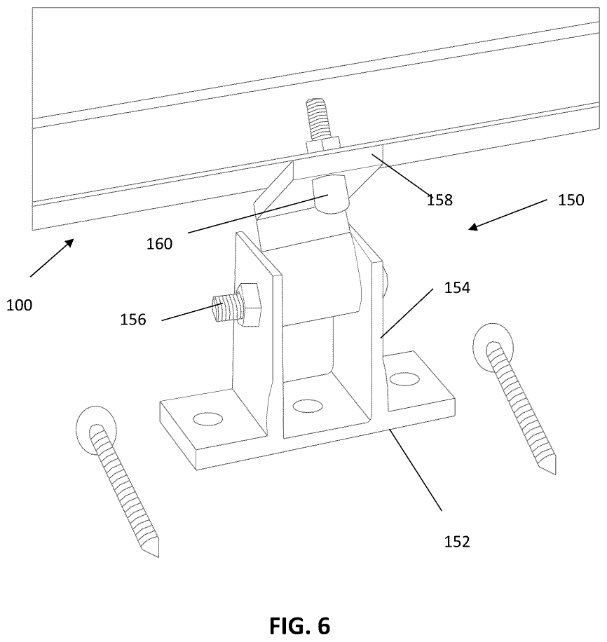

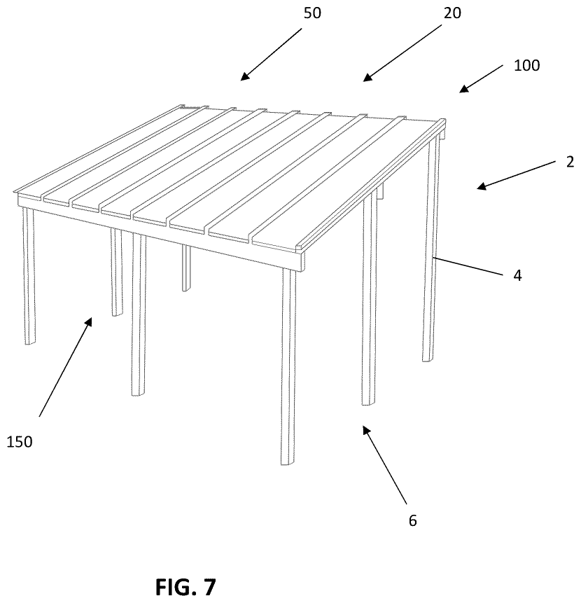

As discussed above, the watertight roof system 20 is retained on the top of the outdoor structure 2 at an adjustable angle through the use of a solar panel pitch connector assembly 150 (or a plurality of solar panel pitch connector assemblies 150) so that any rain, snow, sleet, hail or other similar type of precipitation will easily run off or drain off of the watertight roof system 20. As shown in FIGS. 6 and 7, solar panel pitch connector assembly 150 includes, in part, bracket 152, extension 154, pivot 156, L-shaped extension 158, and fastener 160. Preferably, solar panel pitch connector assembly 150 is constructed of any suitable, durable, high strength, rust resistant, UV-resistant metallic material such as aluminum. Alternatively, the conventional posts 4 can also be cut at the preferred angle and mounted directly to the butterfly and end rails 102 and 104, respectively.

In order to secure the solar panel assembly 60 and the rail assembly 100 to the outside structure 2, a plurality of brackets 152 of solar panel pitch connector assembly 150 are conventionally secured by fasteners (not shown) to crossbeam 8 along pre-determined locations along crossbeam 8. The L-shaped extension 158 is then connected along predetermined locations to end rails 104 through the use of fasteners 160. Extension 154, pivot 156, and L-shaped extension 158 can be used to adjust a pitch of the watertight roofing system 20. It is to be understood that a plurality of solar panel pitch connector assemblies 150 can be located along a length of the rail assembly 100 in order to assist in adjusting the pitch of the watertight roofing system 20.

Solar panel pitch connector assembly 150 allows pitch of the watertight roofing system 20 to be adjusted in order to adjust the amount of sunlight that can interact with the solar panel assemblies 60 and to adjust the amount of precipitation that may possibly collect on the top of the solar panel assemblies. In particular, the pitch of the watertight roofing system 20 can be adjusted by rotating the plurality of L-shaped extensions 158 connected to the bottom of the watertight roofing system 20 until the desired pitch has been reached. The pivots 156 can then be conventionally tightened so that the L-shaped extensions 158 remain in place. As discussed above, alternatively, it is to be understood that posts 4 could be conventionally cut in order to provide the desired roof pitch instead of using the solar panel pitch connector assembly 150.

Another unique aspect of the present invention is the curb appeal of the outdoor structure 2. In particular, by using vinyl, aluminum, or rigid PVC options for a sealed roofing system 20, both the car port and veranda style units are very functional in appearance for both commercial and home use.

Still another unique aspect of the present invention is that the outdoor structure 2 reduces construction costs and time by customizing a roofing system 20 for each individual installation. As discussed above, there is no standard system to accept solar panels that is watertight and has a range in the curvature of the rail angle from 1.2″ to 1.5″ to accept the top four (4) type solar panel producers in the world. The ease of installation, portability, and the fact that several outdoor structures 2 can be combined together to make a wide range of veranda size patio roof enclosures ranging from 7.5′ to 30′ wide and 14′ to 24′ in length. This allows for several combinations of outdoor structures 2 to fit in multiple driveway configurations and separate stand-alone units in back yards or commercial areas to provide a veranda style shade covering that is watertight and also has the capability to produce solar energy.

### Electricity Feed Back to Electrical Grid

Finally, with respect to FIG. 8, the watertight roofing system 20 and bifacial solar panels 50 can be used to back feed electricity produced by the bifacial solar panels 50 into the national grid systems. In particular, as shown in FIG. 8, there are two (2) different circuits (embodiments).

In the first circuit embodiment, the solid line shows electric power being conducted from the bifacial solar panels 50 to solar connector collar 230 attached to the electric power meter 220 associated with the residence 200. In one embodiment, solar connector collar 230 acts as an inverter by inverting the AC power generated by the bifacial solar panels 50. It then goes from the electric power meter 220 to residential circuit breaker box 210 to provide power to the residence 200. Also, some of the generated electrical power is transmitted through the electric power meter 220 to a transformer 310 on the power grid 300. This embodiment allows the bifacial solar panels 50 to provide solar power to the electrical appliances (not shown) associated with the residence 200, and also sends the overflow electrical power to the electric power grid 300. The user will get at least some credit for the power pumped back into the electric power grid.

In the second circuit embodiment, the dashed line shows the electricity generated by the bifacial solar panels 50 of the watertight roofing system 20 going directly from the bifacial solar panels 50 to solar connector collar 230 on the electric power meter 220 and then to the transformer 310 on the power grid 300. It is to be understood that in this embodiment, electric power generated by the bifacial solar panels 50 is not transmitted to the residence 200, so all of the electricity generated by the bifacial solar panels 50 is transmitted to the electrical grid 300 for a larger electrical generation credit than in the first circuit embodiment.

While it has not been mentioned, one familiar with the art would realize that the device is not limited by the materials used to create each apparatus that comprises the invention. Any other material type can comprise some or all of the elements in constructing an outdoor structure such as a veranda, pergola, car port, gazebo or the like wherein the outdoor structure has a watertight roofing system which includes solar panels in various embodiments of the present invention.

Although the present invention has been illustrated and described herein with reference to preferred embodiments and specific examples, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A roofing system for an outdoor structure, comprising:
an outdoor structure; and
a roofing system, wherein the roofing system further comprises:
at least one bifacial solar panel assembly configured to produce solar energy, and
a rail assembly, wherein the at least one bifacial solar panel assembly is removably retained within the rail assembly, and
the rail assembly includes a plurality of extensions that contact an upper side of the least one bifacial solar panel assembly to create a watertight seal around a periphery of the at least one bifacial solar assembly.

2. The roofing system, according to claim 1, wherein the outdoor structure further comprises:
a plurality of posts; and
a plurality of crossbeams operatively connected to the plurality of posts.

3. The roofing system, according to claim 1, wherein the rail assembly further comprises:
at least one butterfly rail;
at least one end rail operatively connected to the at least one butterfly rail; and
at least one butterfly connector operatively connected to the at least one end rail.

4. The roofing system, according to claim 3, wherein the at least one butterfly rail further comprises:
a butterfly rail frame;
a top wall operatively connected to the butterfly rail frame;
at least one extension operatively connected to the top wall;
a bottom wall operatively connected to the butterfly rail frame; and
a frame opening located between the butterfly rail frame, the top wall, and the bottom wall.

5. The roofing system, according to claim 3, wherein the at least one end rail further comprises:
an end rail frame;
a top wall operatively connected to the end rail frame;
at least one extension operatively connected to the top wall;
a bottom wall operatively connected to the end rail frame; and
a frame opening located between the end rail frame, the top wall, and the bottom wall.

6. The roofing system, according to claim 3, wherein the at least butterfly connector further comprises:
a butterfly connector frame;
a top wall operatively connected to the butterfly connector frame;
at least one extension operatively connected to the top wall; and
a bottom wall operatively connected to the butterfly connector frame.

7. The roofing system, according to claim 1, wherein the roofing system further comprises:
at least one solar panel pitch connector assembly, wherein the solar panel pitch connector assembly further comprises:
a bracket,
an extension operatively connected to the bracket,
a pivot operatively connected to the extension,
an L-shaped extension operatively connected to the pivot, wherein the L-shaped extension rotates within the extension, and
a fastener operatively connected to the rail assembly.

8. A method of constructing a roofing system for an outdoor structure, comprising:
providing an outdoor structure; and
providing a roofing system, wherein the roofing system further comprises:
at least one bifacial solar panel assembly configured to produce solar energy, and
a rail assembly, wherein the at least one bifacial solar panel assembly is removably retained within the rail assembly, and
the rail assembly includes a plurality of extensions that contact an upper side of the least one bifacial solar panel assembly to create a watertight seal around a periphery of the at least one bifacial solar assembly.

9. The method, according to claim 8, wherein the outdoor structure further comprises:
providing a plurality of posts; and
attaching a plurality of crossbeams to the plurality of posts.

10. The method, according to claim 8, wherein the rail assembly further comprises:
providing at least one butterfly rail;
attaching at least one end rail to the at least one butterfly rail; and
attaching at least one butterfly connector to the at least one end rail.

11. The method, according to claim 10, wherein the at least one butterfly rail further comprises:
providing a butterfly rail frame;
attaching a top wall to the butterfly rail frame;
attaching at least one extension to the top wall;
attaching a bottom wall to the butterfly rail frame; and
creating a frame opening between the butterfly rail frame, the top wall, and the bottom wall.

12. The method, according to claim 10, wherein the at least one end rail further comprises:
providing an end rail frame;
attaching a top wall to the end rail frame;
attaching at least one extension to the top wall;
attaching a bottom wall to the end rail frame; and
creating a frame opening between the end rail frame, the top wall, and the bottom wall.

13. The method, according to claim 10, wherein the at least butterfly connector further comprises:
providing an butterfly connector frame;
attaching a top wall operatively to the butterfly connector frame;
attaching at least one extension to the top wall; and
attaching a bottom wall to the butterfly connector frame.

14. The method, according to claim 8, wherein the method further comprises:
providing at least one solar panel pitch connector assembly, wherein the solar panel pitch connector assembly further comprises:
a bracket,
an extension operatively connected to the bracket,
a pivot operatively connected to the extension,
an L-shaped extension operatively connected to the pivot, wherein the L-shaped extension rotates within the extension, and
a fastener operatively connected to the rail assembly.

15. A method of using a roofing system for an outdoor structure, comprising:
providing an outdoor structure;
providing a roofing system, wherein the roofing system further comprises:
at least one bifacial solar panel assembly configured to produce solar energy, and
a rail assembly, wherein the at least one bifacial solar panel assembly is removably retained within the rail assembly, and
the rail assembly includes a plurality of extensions that contact an upper side of the least one bifacial solar panel assembly to create a watertight seal around a periphery of the at least one bifacial solar assembly; and
using the at least one bifacial solar panel assembly to produce solar energy.

16. The method, according to claim 15, wherein the outdoor structure further comprises:
providing a plurality of posts; and
attaching a plurality of crossbeams to the plurality of posts.

17. The method, according to claim 15, wherein the rail assembly further comprises:
providing at least one butterfly rail;
attaching at least one end rail to the at least one butterfly rail; and
attaching at least one butterfly connector to the at least one end rail.

18. The method, according to claim 17, wherein the at least one butterfly rail further comprises:
providing a butterfly rail frame;
attaching a top wall to the butterfly rail frame;
attaching at least one extension to the top wall;
attaching a bottom wall to the butterfly rail frame; and
creating a frame opening between the butterfly rail frame, the top wall, and the bottom wall.

19. The method, according to claim 17, wherein the at least one end rail further comprises:
providing an end rail frame;
attaching a top wall to the end rail frame;
attaching at least one extension to the top wall;
attaching a bottom wall to the end rail frame; and
creating a frame opening between the end rail frame, the top wall, and the bottom wall.

20. The method, according to claim 15, wherein the method further comprises:
providing at least one solar panel pitch connector assembly, wherein the solar panel pitch connector assembly further comprises:
a bracket,
an extension operatively connected to the bracket,
a pivot operatively connected to the extension,
an L-shaped extension operatively connected to the pivot, wherein the L-shaped extension rotates within the extension, and
a fastener operatively connected to the rail assembly; and
using the at least one solar panel pitch connector assembly to change a pitch of roofing system.
